(19) United States
(12) Patent Application Publication
(10) Pub. No.: US 2005/0251403 A1
(43) Pub. Date: Nov. 10, 2005

(54) Mesh AMR network interconnecting to TCP/IP wireless mesh network

(75) Inventor: Kenneth C. Shuey, Zebulon, NC (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Elster Electricity, LLC.

(21) Appl. No.: 10/937,436

(22) Filed: Sep. 9, 2004

Related U.S. Application Data
(63) Continuation-in-part of application No. 10/842,408, filed on May 10, 2004.

(51) Int. Cl. G06F 17/60

(52) U.S. Cl. 705/1

(57) ABSTRACT

A wireless system for collecting metering data that includes a plurality of meters, a collector and a central communications server. The meters communicate usage data to either the collector or the central server via a Wi-Fi and/or WiMax wireless communications network. The Wi-Fi and/or WiMax network can operate independently of, or in conjunction with, existing data gathering wireless networks.

### CROSS-REFERENCE TO RELATED APPLICATIONS

The present invention claims the benefit of priority from U.S. patent application Ser. No. 10/842,408, filed May 10, 2004, which is incorporated herein by reference in its entirety.

### FIELD OF THE INVENTION

The present invention relates to metering systems, and more particularly, to wireless networks for gathering metering data.

### BACKGROUND OF THE INVENTION

The collection of meter data from electrical energy, water, and gas meters has traditionally been performed by human meter-readers. The meter-reader travels to the meter location, which is frequently on the customer's premises, visually inspects the meter, and records the reading. The meter-reader may be prevented from gaining access to the meter as a result of inclement weather or, where the meter is located within the customer's premises, due to an absentee customer. This methodology of meter data collection is labor intensive, prone to human error, and often results in stale and inflexible metering data.

Some meters have been enhanced to include a one-way radio transmitter for transmitting metering data to a receiving device. A person collecting meter data that is equipped with an appropriate radio receiver need only come into proximity with a meter to read the meter data and need not visually inspect the meter. Thus, a meter-reader may walk or drive by a meter location to take a meter reading. While this represents an improvement over visiting and visually inspecting each meter, it still requires human involvement in the process.

An automated means for collecting meter data involves a fixed wireless network. Devices such as, for example, repeaters and gateways are permanently affixed on rooftops and pole-tops and strategically positioned to receive data from enhanced meters fitted with radio-transmitters. Typically, these transmitters operate in the 902-928 MHz range and employ Frequency Hopping Spread Spectrum (FHSS) technology to spread the transmitted energy over a large portion of the available bandwidth.

Data is transmitted from the meters to the repeaters and gateways and ultimately communicated to a central location. While fixed wireless networks greatly reduce human involvement in the process of meter reading, such systems require the installation and maintenance of a fixed network of repeaters, gateways, and servers. Identifying an acceptable location for a repeater or server and physically placing the device in the desired location on top of a building or utility pole is a tedious and labor-intensive operation. Furthermore, each meter that is installed in the network needs to be manually configured to communicate with a particular portion of the established network. When a portion of the network fails to operate as intended, human intervention is typically required to test the effected components and reconfigure the network to return it to operation.

Thus, while existing fixed wireless systems have reduced the need for human involvement in the daily collection of meter data, such systems require substantial human investment in planning, installation, and maintenance and are relatively inflexible and difficult to manage. Therefore, there is a need for a wireless system that leverages emerging ad-hoc wireless technologies to simply the installation and maintenance of such systems.

### SUMMARY OF THE INVENTION

A wireless system for collecting metering data that includes a plurality of meters, a collector and a central communications server. The meters communicate usage data to either the collector or the central server via a WiMax, Wi-Fi or a combination of these wireless communications. The WiMax or Wi-Fi network can operate independently of, or in conjunction with, existing data gathering wireless networks.

In accordance with one aspect of the invention, there is provided a system for collecting metering data via a wireless network. The system includes a plurality of meters that gather usage data related to a commodity and that have an address, a collector that gathers the usage data via the wireless network from the plurality of meters, and a central communications server that receives the usage data from the collector. The wireless network is a TCP/IP wireless mesh network (e.g., an IEEE 802.11x or IEEE 802.16 network).

According to a feature of the invention, the predetermined ones of the plurality of meters are registered as part of a subnet. The collector may communicate instructions to predetermined ones of the plurality of meters in the subnet, where the instructions are part of a broadcast message.

According to another feature of the invention, the addresses in the wireless network may be Internet Protocol addresses. As such, communications between the plurality of meters, the collector and the central server may be made via a TCP/IP connection. Also, at least one TCP/IP connection may be made over a public network. The meters may be remotely configurable using the addresses.

According to another aspect of the invention, there is provided a TCP/IP wireless mesh network system for collecting metering data. The system includes a plurality of meters that gather usage data related to a commodity and having an Internet Protocol address, and a central communications server that receives the usage data from each of the plurality of meters via TCP/IP connections.

According to yet another aspect of the invention, there is provided a system for collecting metering data via a plurality of wireless networks. In the system, a first wireless network includes a first plurality of meters and a first collector that gathers usage data from the first meters via the first wireless network. A second wireless network includes a second plurality of meters and a second collector that gathers the usage data via the second wireless network from the second plurality of meters. A central communications server receives the usage data from the first collector and/or the second collector. In accordance with this aspect of the invention, the first wireless network is a spread spectrum wireless network and/or a TCP/IP wireless network, and the second network is a wireless network is a TCP/IP wireless mesh network.

Additional features and advantages of the invention will be made apparent from the following detailed description of illustrative embodiments that proceeds with reference to the accompanying drawings.

### BRIEF DESCRIPTION OF THE DRAWINGS

Other features of systems and methods for gathering metering data are further apparent from the following detailed description of exemplary embodiments taken in conjunction with the accompanying drawings, of which:

FIG. 1 is a diagram of a wireless system for collecting meter data;

FIG. 2 is a diagram of a wireless system for collecting meter data via a Wi-Fi or WiMax network using one of conventional circuit switch, digital cellular WAN, WiMax WAN, etc. connection to the collector;

FIG. 3 is a diagram of a wireless system including a combination of 902-928 MHz and Wi-Fi networks with conventional circuit switch or digital cellular WAN connection to the collector;

FIG. 4 is a diagram of a wireless system including a combination of 902-928 MHz and WiMax networks with conventional circuit switch or digital cellular WAN connection to the collector;

FIG. 5 is a diagram of a wireless system including a combination of 902-928 MHz, Wi-Fi, and WiMax AMR networks with a WiMax WAN connection to at least one collector;

FIG. 6 is a diagram of a Wi-Fi and/or WiMax network where meters communicate directly to a central communication server; and

FIG. 7 is a diagram of a general purpose computing device.

### DETAILED DESCRIPTION OF ILLUSTRATIVE EMBODIMENTS

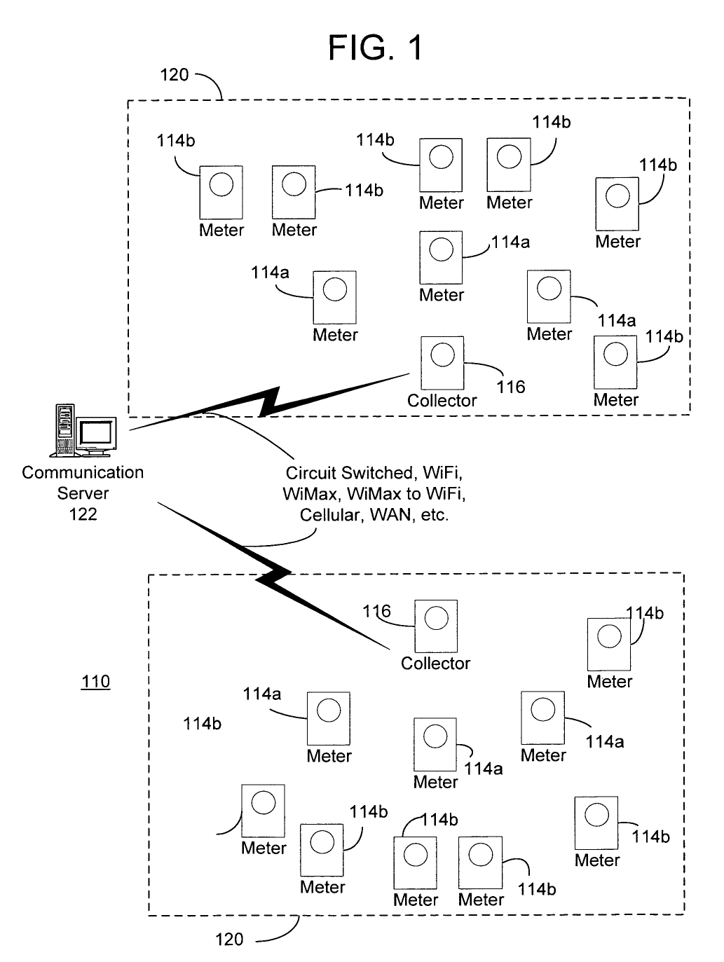

Exemplary systems and methods for gathering meter data are described below with reference to FIGS. 1-7. It will be appreciated by those of ordinary skill in the art that the description given herein with respect to those figures is for exemplary purposes only and is not intended in any way to limit the scope of potential embodiments.

Generally, a plurality of meter devices, which operate to track usage of a service or commodity such as, for example, electricity, water, and gas, are operable to wirelessly communicate with each other. A collector is operable to automatically identify and register meters for communication with the collector. When a meter is installed, the meter becomes registered with the collector that can provide a communication path to the meter. The collectors receive and compile metering data from a plurality of meter devices via wireless communications. A communications server communicates with the collectors to retrieve the compiled meter data.

FIG. 1 provides a diagram of an exemplary metering system 110. System 110 comprises a plurality of meters 114, which are operable to sense and record usage of a service or commodity such as, for example, electricity, water, or gas. Meters 114 may be located at customer premises such as, for example, a home or place of business. Meters 114 comprise an antenna and are operable to transmit data, including service usage data, wirelessly. Meters 114 may be further operable to receive data wirelessly as well. In an illustrative embodiment, meters 114 may be, for example, a electrical meters manufactured by Elster Electricity, LLC.

System 110 further comprises collectors 116. Collectors 116 are also meters operable to detect and record usage of a service or commodity such as, for example, electricity, water, or gas. Collectors 116 comprise an antenna and are operable to send and receive data wirelessly. In particular, collectors 116 are operable to send data to and receive data from meters 114. In an illustrative embodiment, meters 114 may be, for example, an electrical meter manufactured by Elster Electricity, LLC.

A collector 116 and the meters 114 for which it is configured to receive meter data define a subnet 120 of system 110. For each subnet 120, data is collected at collector 116 and periodically transmitted to communication server 122. Communication server 122 stores the data for analysis and preparation of bills. Communication server 122 may be a specially programmed general purpose computing system and may communicate with collectors 116 wirelessly or via a wire line connection such as, for example, a dial-up telephone connection or fixed wire network. By example, the communication from the collector 116 to the server 122 could be via any available communication link, such as a public network (PSTN), a Wi-Fi network (IEEE 802.11), a WiMax network (IEEE 802.16), a combination WiMax to Wi-Fi network, WAN, TCP/IP wireless network, etc. Further, communication between collectors 116 and the communication server 120 is two-way where either may originate commands and/or data.

Thus, each subnet 120 comprises a collector 116 and one or more meters 114, which may be referred to as nodes of the subnet. Typically, collector 116 directly communicates with only a subset of the plurality of meters 114 in the particular subnet. Meters 114 with which collector 116 directly communicates may be referred to as level one meters 114a. The level one meters 114a are said to be one “hop” from the collector 116. Communications between collector 116 and meters 114 other than level one meters 114a are relayed through the level one meters 114a. Thus, the level one meters 114a operate as repeaters for communications between collector 116 and meters 114 located further away in subnet 120.

Each level one meter 114a directly communicates with only a subset of the remaining meters 114 in the subnet 120. The meters 114 with which the level one meters 114a directly communicate may be referred to as level two meters 114b. Level two meters 114b are one “hop” from level one meters 114a, and therefore two “hops” from collector 116. Level two meters 114b operate as repeaters for communications between the level one meters 114a and meters 114 located further away from collector 116 in the subnet 120.

While only three levels of meters are shown (collector 114, first level 114a, second level 114b) in FIG. 1, a subnet 120 may comprise any number of levels of meters 114. For example, a subnet 120 may comprise one level of meters but might also comprise eight or more levels of meters 114. In an embodiment wherein a subnet comprises eight levels of meters 114, as many as 1000 or more meters might be registered with a single collector 116.

Each meter 114 and collector 116 that is installed in the system 110 has a unique identifier stored thereon that uniquely identifies the device from all other devices in the system 110. Additionally, meters 114 operating in a subnet 120 comprise information including the following: data identifying the collector with which the meter is registered; the level in the subnet at which the meter is located; the repeater meter with which the meter communicates to send and receive data to the collector; an identifier indicating whether the meter is a repeater for other nodes in the subnet; and if the meter operates as a repeater, the identifier that uniquely identifies the repeater within the particular subnet, and the number of meters for which it is a repeater. Collectors 116 have stored thereon all of this same data for all meters 114 that are registered therewith. Thus, collector 116 comprises data identifying all nodes registered therewith as well as data identifying the registered path by which data is communicated with each node.

Generally, collector 116 and meters 114 communicate with and amongst one another using any one of several robust wireless techniques such as, for example, frequency hopping spread spectrum (FHSS) and direct sequence spread spectrum (DSSS).

For most network tasks such as, for example, reading data, collector 116 communicates with meters 114 in the subnet 120 using point-to-point transmissions. For example, a message or instruction from collector 116 is routed through a defined set of meter hops to the desired meter 114. Similarly, a meter 114 communicates with collector 116 through the same set of meter hops, but in reverse.

In some instances, however, collector 116 needs to quickly communicate information to all meters 114 located in its subnet 120. Accordingly, collector 116 may issue a broadcast message that is meant to reach all nodes in the subnet 120. The broadcast message may be referred to as a “flood broadcast message.” A flood broadcast originates at collector 116 and propagates through the entire subnet 120 one level at a time. For example, collector 116 may transmit a flood broadcast to all first level meters 114a. The first level meters 114a that receive the message pick a random time slot and retransmit the broadcast message to second level meters 114b. Any second level meter 114b can accept the broadcast, thereby providing better coverage from the collector out to the end point meters. Similarly, the second level meters 114b that receive the broadcast message pick a random time slot and communicate the broadcast message to third level meters. This process continues out until the end nodes of the subnet. Thus, a broadcast message gradually propagates out the subnet 120.

The flood broadcast packet header contains information to prevent nodes from repeating the flood broadcast packet more than once per level. For example, within a flood broadcast message, a field might exist that indicates to meters/nodes which receive the message, the level of the subnet the message is located; only nodes at that particular level may re-broadcast the message to the next level. If the collector broadcasts a flood message with a level of 1, only level 1 nodes may respond. Prior to re-broadcasting the flood message, the level 1 nodes increment the field to 2 so that only level 2 nodes respond to the broadcast. Information within the flood broadcast packet header ensures that a flood broadcast will eventually die out.

Generally, a collector 116 issues a flood broadcast several times, e.g. five times, successively to increase the probability that all meters in the subnet 120 receive the broadcast. A delay is introduced before each new broadcast to allow the previous broadcast packet time to propagate through all levels of the subnet.

Meters 114 may have a clock formed therein. However, meters 114 often undergo power interruptions that can interfere with the operation of any clock therein. Accordingly, the clocks internal to meters 114 cannot be relied upon to provide an accurate time reading. Having the correct time is necessary, however, when time of use metering is being employed. Indeed, in an embodiment, time of use schedule data may also be comprised in the same broadcast message as the time. Accordingly, collector 116 periodically flood broadcasts the real time to meters 114 in subnet 120. Meters 114 use the time broadcasts to stay synchronized with the rest of the subnet 120. In an illustrative embodiment, collector 116 broadcasts the time every 15 minutes. The broadcasts may be made near the middle of 15 minute clock boundaries that are used in performing load profiling and time of use (TOU) schedules so as to minimize time changes near these boundaries. Maintaining time synchronization is important to the proper operation of the subnet 120. Accordingly, lower priority tasks performed by collector 116 may be delayed while the time broadcasts are performed.

In an illustrative embodiment, the flood broadcasts transmitting time data may be repeated, for example, five times, so as to increase the probability that all nodes receive the time. Furthermore, where time of use schedule data is communicated in the same transmission as the timing data, the subsequent time transmissions allow a different piece of the time of use schedule to be transmitted to the nodes.

Exception messages are used in subnet 120 to transmit unexpected events that occur at meters 114 to collector 116. In an embodiment, the first 4 seconds of every 32-second period are allocated as an exception window for meters 114 to transmit exception messages. Meters 114 transmit their exception messages early enough in the exception window so the message has time to propagate to collector 116 before the end of the exception window. Collector 116 may process the exceptions after the 4-second exception window. Generally, a collector 116 acknowledges exception messages, and collector 116 waits until the end of the exception window to send this acknowledgement.

In an illustrative embodiment, exception messages are configured as one of three different types of exception messages: local exceptions, which are handled directly by the collector 116 without intervention from communication server 122; an immediate exception, which is generally relayed to communication server 122 under an expedited schedule; and a daily exception, which is communicated to the communication server 122 on a regular schedule.

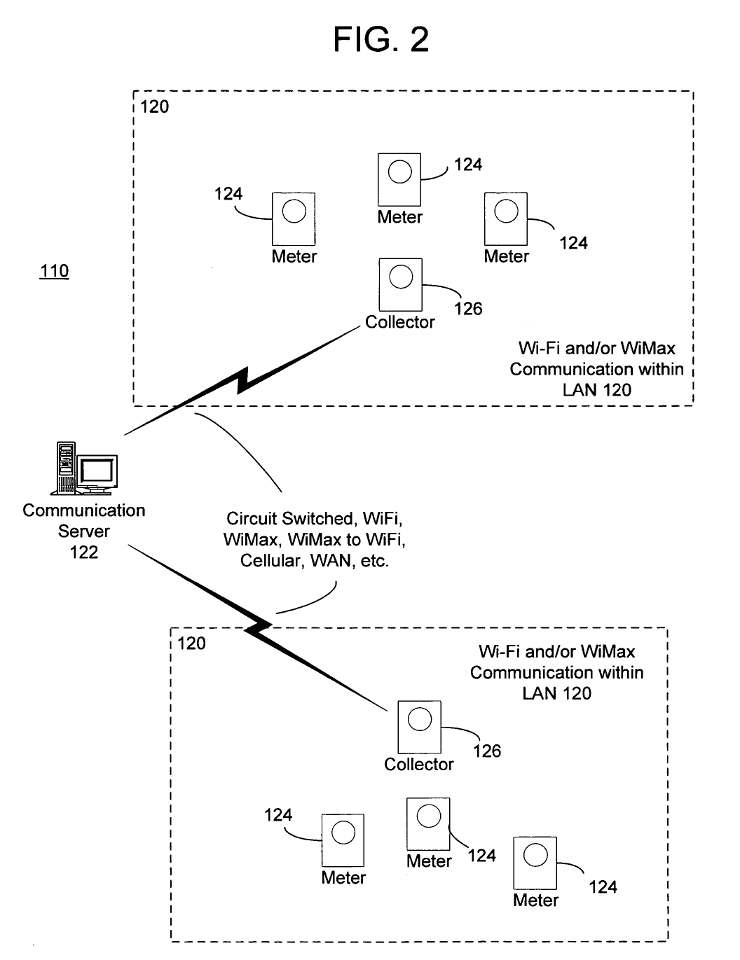

Referring now to FIG. 2, there is illustrated a metering system 110 where the subnets 120 include meters 124 and a collector 126 that communicate to each other via a Wi-Fi (Wireless Fidelity) wireless network. Wi-Fi networks use radio technologies defined by various IEEE 802.11 standards and allow devices to connect to the Internet and other networks to send and receive data anywhere within the range of a base station. A particular advantage of using a Wi-Fi network is that it is an inexpensive and practical way to share a network connection. Extensions of the Wi-Fi protocol allow the Wi-Fi radios to operate in mesh networks such that meters may communicate with other meters without the requirement of direct connection with a base station. Communication with the communication server 122 can be accomplished using any available communications ink.

Wi-Fi networks operate in the unlicensed 2.4 or 5 GHz radio bands, with data rates of 11 Mbps or 54 Mbps. A Wi-Fi network generally provides a range of about 75 to 150 feet in typical applications. In an open environment like an empty warehouse or outdoors, a Wi-Fi network may provide a range of up to 1,000 feet or more. The range varies depending on the type of Wi-Fi radio, whether special antennas are used, and whether the network is obstructed by walls, floors and furniture, etc. The composition of walls and floors can have a major impact as Wi-Fi is a very low powered radio signal and does not penetrate metal, water or other dense materials.

Also in accordance with FIG. 2, the subnets 120 may include meters 124 and a collector 126 that communicate to each other via a WiMax wireless network. WiMax networks use radio technologies defined by various IEEE 802.16 standards and allow devices to connect to the Internet and other networks to send and receive data anywhere within the range of a base station. A particular advantage of using a WiMax network is that it is an inexpensive and practical way to share a network connection. The WiMax protocol standard includes a mesh networking capability so meters can communicate with each other as well as with a base station. Here again, communication with the communication server 122 can be accomplished via any available communications link.

WiMax networks operate in the unlicensed 2-11 GHz radio band, with data rates up to 75 Mbps. A WiMax network generally provides a range of about 1-30 miles in typical tower based applications. In a residential environment, a WiMax network may provide a range of up to a few thousand feet between homes. The range will vary depending on the type of WiMax radio, whether special antennas are used, and whether the network is obstructed or not. The composition of walls and floors can have a major impact as WiMax is a moderately powered radio signal and does not penetrate dense materials very well.

In each subnet 120 of FIG. 2, the collector 126 includes a Wi-Fi and/or WiMax base station (access point), as appropriate. The meters 124 communicate to the collector 126 and each other via the Wi-Fi and/or WiMax network, standard TCP/IP protocols and mesh networking enhancements to the basic Wi-Fi protocol and/or the mesh capabilities of the WiMax protocol. The collector may connect to the communication server 122 via a any available communications link, such as a conventional circuit switched or digital cellular connection, or via a WiMax connection and TCP/IP protocols. Because the meters 124 and collector 126 are addressable via an IP address, they can be configured remotely, thus reducing the need for technicians/installers to physically access the meters to configure and troubleshoot them. Also, the collector 126 may be configured to use a “hot spot” (an access point that the general public can use) to transmit data to the communication server 122. To ensure that there is secure communication of critical billing information, etc. between the meters 124, collector 126 and the communication server 122, an implementation such as that used in U.S. Pat. No. 6,393,341 may be used.

Because the range of a Wi-Fi network is more limited that that of the 902-928 MHz network, Wi-Fi networks are better suited for high density applications, such as in urban environments. To ensure connectivity of the meter 124, the installer preferably verifies that the meter 124 is able to communicate to the collector 126 (or other meter 124 or node capable of relaying data to the collector 126) by e.g., pinging the collector 126 at its assigned IP address. It is noted that the meters 124 and collector 126 may accumulate and communicate data in a similar manner to the meters 114 and collector 116; however the wireless transmission would be over a Wi-Fi network.

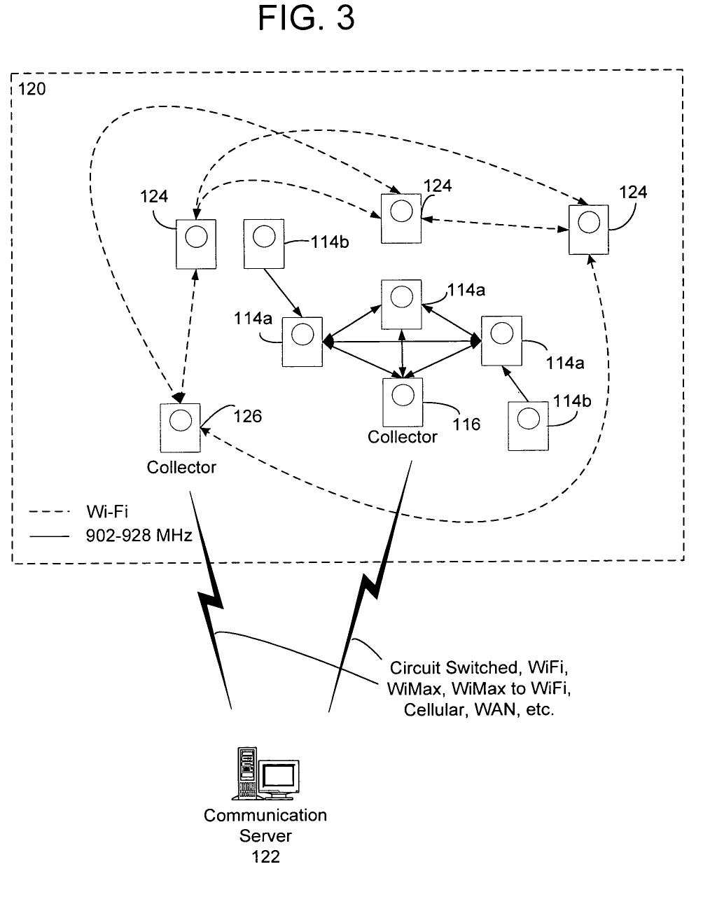

Referring to FIG. 3, there is illustrated an exemplary subnet 120 where a 902-928 MHz network and a Wi-Fi network are each implemented in the subnet 120. In this exemplary embodiment, the networks operate independently to provide the maximum coverage within a geographic area while attempting to utilize Wi-Fi where possible. In this topology, meters 114 communicate to collector 116 and meters 124 communicate to collector 126. The collectors 116 and 126 transmit their data to the communications server 122 via separate communications links. Alternatively, the meters 124 may transmit their usage data directly to the communication server 122, rather than through the collector 126.

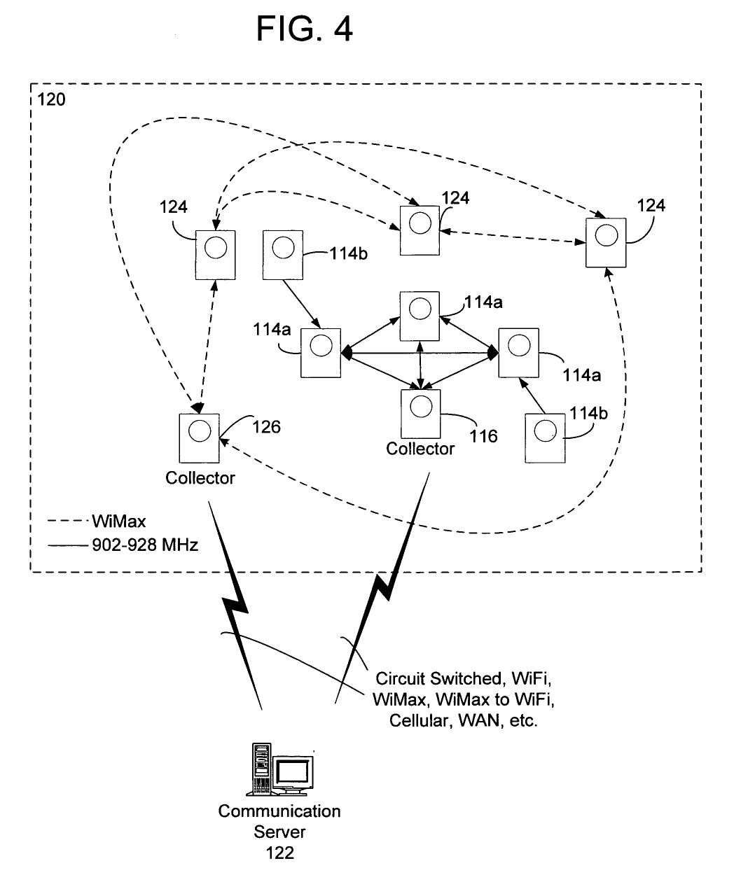

Referring to FIG. 4, there is illustrated an exemplary subnet 120 where a 902-928 MHz network and a WiMax network are each implemented in the subnet 120. In this exemplary embodiment, the networks operate independently to provide the maximum coverage within a geographic area while attempting to utilize WiMax where possible. In this topology, meters 114 communicate to collector 116 and meters 124 communicate to collector 126. The collectors 116 and 126 transmit their data to the communications server 122 via a separate communications links. Alternatively, the meters 124 may transmit their usage data directly to the communication server 122, rather than through the collector 126.

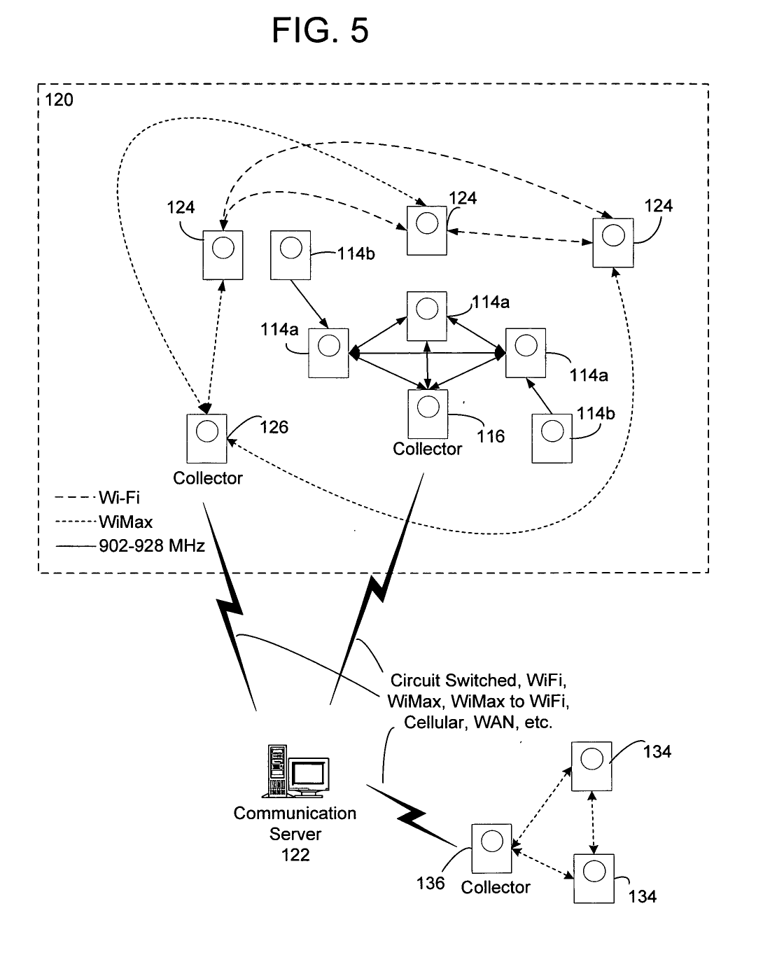

Referring to FIG. 5, there is illustrated an exemplary subnet 120 where a 902-928 MHz network, a Wi-Fi network and a WiMax network are each implemented in the subnet 120. In this exemplary embodiment, the networks operate independently to provide the maximum coverage within a geographic area while attempting to utilize Wi-Fi and WiMax where possible. In this topology, the meters 114 communicate to the collector 116, the meters 124 communicate to collector the 126 and meters the 134 communicate to a collector 136. The collectors 116, 126 and 136 transmit their data to the communications server 122 via WiMax communications links. Alternatively, the meters 124 and 134 may transmit their usage data directly to the communication server 122, rather than through the collectors 126 or 136.

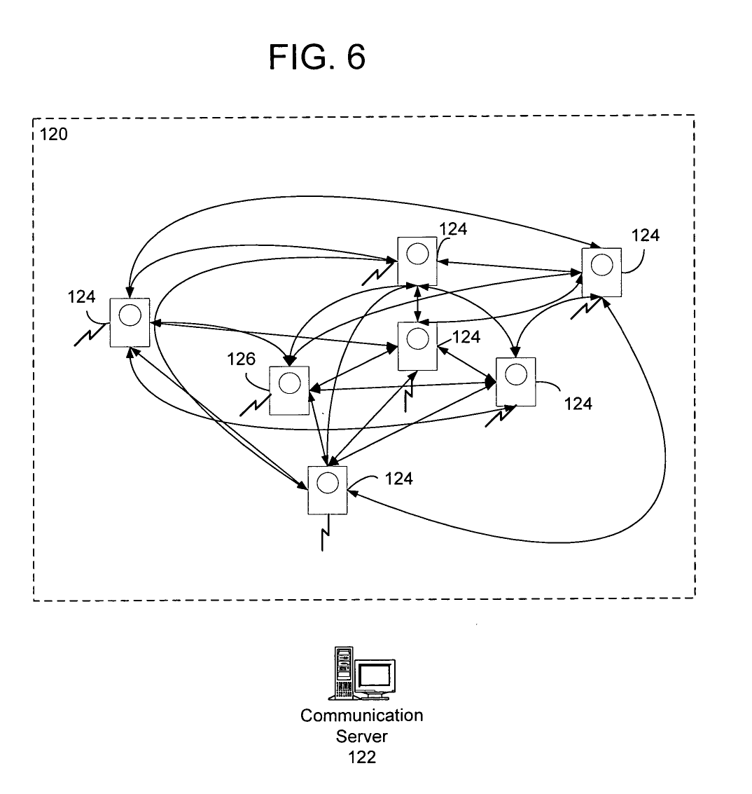

Referring to FIG. 6, there is illustrated yet another exemplary subnet 120 having sufficient Wi-Fi and/or WiMax infrastructure in place to forego a 902-928 MHz network. Here, it is preferable that the meters 124 communicate with each other and directly to the communication server 122 via the Wi-Fi network. This eliminates the need for a collector 126/136 in the topology.

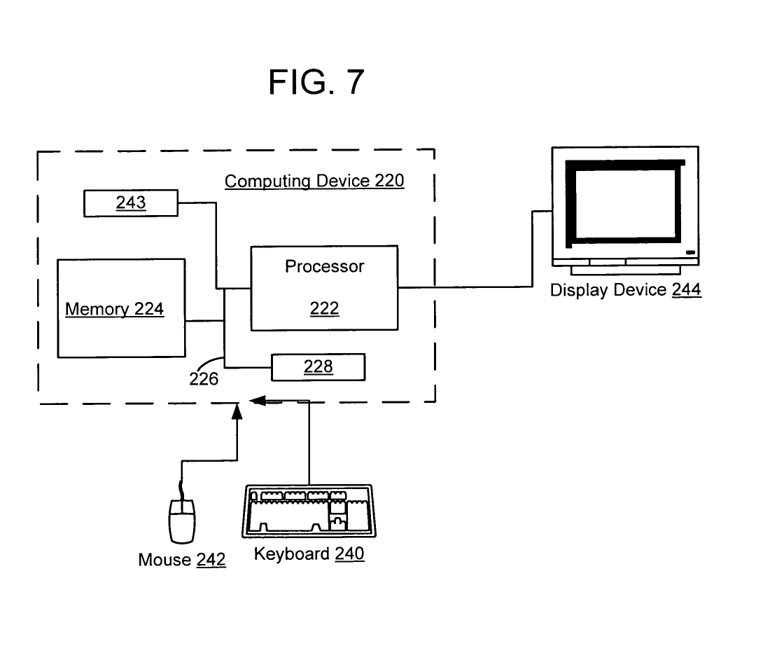

FIG. 7 is a diagram of a generic computing device, which may be operable to perform the steps described above as being performed by communications server 122. As shown in FIG. 5, communications server 222 includes processor 222, system memory 224, and system bus 226 that couples various system components including system memory 224 to processor 222. System memory 224 may include read-only memory (ROM) and/or random access memory (RAM). Computing device 220 may further include hard-drive 228, which provides storage for computer readable instructions, data structures, program modules, data, and the like. A user (not shown) may enter commands and information into the computing device 220 through input devices such as keyboard 240 or mouse 242. A display device 244, such as a monitor, a flat panel display, or the like is also connected to computing device 220. Communications device 243, which may be a modem, network interface card, or the like, provides for communications over a network. System memory 224 and/or hard-drive 228 may be loaded with any one of several computer operating systems such as WINDOWS XP or WINDOWS SERVER 2003 operating systems, LINUX operating system, and the like.

While systems and methods have been described and illustrated with reference to specific embodiments, those skilled in the art will recognize that modification and variations may be made without departing from the principles described above and set forth in the following claims. Accordingly, reference should be made to the following claims as describing the scope of disclosed embodiments.

1. A system for collecting metering data via a wireless network, comprising:
a plurality of meters, each of said plurality of meters gathering usage data related to a commodity and having an address;
a collector that gathers said usage data via said wireless network from predetermined ones of said plurality of meters, said collector having a collector address; and
a central communications server that receives said usage data from said collector,
wherein said wireless network comprises a wireless TCP/IP mesh network.

2. The system of claim 1, wherein said predetermined ones of said plurality of meters are registered as part of a subnet.

3. The system of claim 2, wherein said collector communicates instructions to said predetermined ones of said plurality of meters in said subnet.

4. The system of claim 3, wherein said collector communicates said instructions in a broadcast message.

5. The system of claim 1, wherein addresses in said wireless network comprise Internet Protocol addresses.

6. The system of claim 5, wherein communications between said plurality of meters, said collector and said central server are made via a TCP/IP connection.

7. The system of claim 6, wherein at least one TCP/IP connection is made over a public network.

8. The system of claim 5, wherein said meters are remotely configurable using said addresses.

9. A TCP/IP wireless mesh network system for collecting metering data, comprising:
a plurality of meters, each of said plurality of meters gathering usage data related to a commodity and having an Internet Protocol address; and
a central communications server that receives said usage data from each of said plurality of meters via TCP/IP connections.

10. The system of claim 9, wherein at least one TCP/IP connection is made over a public network.

11. The system of claim 9, wherein said meters are remotely configurable using said Internet Protocol address for each meter.

12. A system for collecting metering data via a plurality of wireless networks, comprising:
a first wireless network comprising:
a first plurality of meters, each of said first plurality of meters gathering usage data related to a commodity and having an address;
a first collector that gathers said usage data via said first wireless network from predetermined ones of said first plurality of meters, said first collector having a collector address; and
a second wireless network comprising:
a second plurality of meters, each of said second plurality of meters gathering usage data related to a commodity and having an address;
a second collector that gathers said usage data via said second wireless network from predetermined ones of said second plurality of meters, said second collector having a collector address;
a central communications server that receives said usage data from said first collector and said second collector,
wherein said first wireless network is a spread spectrum wireless network or a TCP/IP wireless mesh network, and wherein said second wireless network comprises a TCP/IP wireless mesh network.

13. The system of claim 12, wherein said predetermined ones of said first plurality of meters are registered as part of a subnet that communicate with said first collector, and wherein said predetermined ones of said second plurality of meters are registered as part of said subnet that communicate with said second collector.

14. The system of claim 12, wherein addresses in said second wireless network comprise Internet Protocol addresses.

15. The system of claim 14, wherein communications between said plurality of second meters, said second collector and said central server are made via a TCP/IP connection.

16. The system of claim 14, wherein at least one TCP/IP connection is made over a public network.

17. The system of claim 14, wherein said second meters are remotely configurable using said addresses.

18. The system of claim 12, wherein said first collector communicates to said central server via a dedicated communications link.
